(19) United States
(12) Patent Application Publication
(10) Pub. No.: US 2026/0103223 A1
(43) Pub. Date: Apr. 16, 2026

(54) DATA PROVISION SYSTEM, DATA PROVISION METHOD, AND RECORDING MEDIUM

(71) Applicant: NEC Corporation, Minato-ku, Tokyo (JP)

(72) Inventors: Shintaro CHIKU, Tokyo (JP); Masanori KUKI, Tokyo (JP)

(73) Assignee: NEC Corporation, Minato-ku, Tokyo (JP)

(21) Appl. No.: 19/115,936

(22) PCT Filed: Nov. 8, 2022
(86) PCT No.: PCT/JP2022/041522

§ 371 Date: Mar. 27, 2025

(51) Int. Cl. B60W 60/00; G05D 1/222; G06Q 50/40; H04N 7/18

(52) U.S. Cl. CPC B60W 60/0025; G05D 1/222; G06Q 50/40; H04N 7/185; B60W 2420/403; B60W 2556/45; B60W 2756/10

(57) ABSTRACT

A data provision system according to an aspect of the present disclosure includes: at least one memory storing instructions; and at least one processor configured to execute the instructions to: accumulate image data transmitted to a control center by a mobile body equipped with an automatic operation mode or an operation mode for operating by means of remote control from the control center; and provide, to a user who wants to utilize the accumulated image data or processed data, the processed data generated by processing the image data.

### TECHNICAL FIELD

The present disclosure relates to a data provision system, a data provision method, and a recording medium.

### BACKGROUND ART

PTL 1 discloses an example of a remote control device that is connected via a communication network and can remotely control a vehicle that can travel by autonomous control and remote control. According to PTL 1, this remote control device displays a visual field image of a vehicle in a visual field image display field provided in a connected monitor.

As described in PTL 1, a method of remotely controlling a vehicle or the like via a wireless network has been proposed. By using a network having characteristics such as high speed, large capacity, and low delay as represented by 5G (5th generation mobile communication system) as a wireless network, an environment in which a higher-definition image can be transmitted and an operation close to real time can be performed is being prepared.

### CITATION LIST

### Patent Literature

PTL 1: JP 2021-179688 A

### SUMMARY OF INVENTION

### Technical Problem

On the other hand, in the process of the remote control, the image transmitted to the control center where the remote control device is disposed is not currently used for other than the control service such as the remote control and the record of the operation content of the operator.

An object of the present disclosure is to provide a data provision system, a data provision method, and a recording medium that can contribute to utilization of image data captured during remote control or automatic operation.

### Solution to Problem

According to a first aspect, there is provided a data provision system including: an accumulation means that accumulates image data transmitted to a control center by a mobile body equipped with an automatic operation mode or an operation mode for operating by means of remote control from the control center; and a provision means that provides, to a user who wants to utilize the accumulated image data or processed data, the processed data generated by processing the image data.

According to a second aspect, there is provided a data provision method including: accumulating image data transmitted to a control center by a mobile body equipped with an automatic operation mode or an operation mode for operating by means of remote control from the control center; and providing, to a user who wants to utilize the accumulated image data or processed data, the processed data generated by processing the image data.

According to a third aspect, there is provided a recording medium having stored therein a program causing a computer to execute: accumulating image data transmitted to a control center by a mobile body equipped with an automatic operation mode or an operation mode for operating by means of remote control from the control center; and providing, to a user who wants to utilize the accumulated image data or processed data, the processed data generated by processing the image data.

### Advantageous Effects of Invention

According to the present disclosure, a data provision system, a data provision method, and a recording medium capable of contributing to utilization of image data captured during remote control or automatic operation are provided.

### BRIEF DESCRIPTION OF DRAWINGS

FIG. 1 is a diagram illustrating a configuration of one example embodiment of the present disclosure.

FIG. 2 is a flowchart illustrating an operation of one example embodiment of the present disclosure.

FIG. 3 is a diagram illustrating a configuration of another example embodiment of the present disclosure.

FIG. 4 is a diagram illustrating a configuration of a data provision system according to a first example embodiment of the present disclosure.

FIG. 5 is a diagram for explaining an example of a holding mode of image data in the data provision system according to the first example embodiment of the present disclosure.

FIG. 6 is a diagram for explaining another example of a holding mode of image data in the data provision system according to the first example embodiment of the present disclosure.

FIG. 7 is a diagram for explaining an example of setting information including image data transmission conditions and the like set in the data provision system according to the first example embodiment of the present disclosure.

FIG. 8 is a flowchart illustrating a data storage operation of the data provision system according to the first example embodiment of the present disclosure.

FIG. 9 is a flowchart illustrating a data transmission operation of the data provision system according to the first example embodiment of the present disclosure.

FIG. 10 is a diagram illustrating an example of image data provided by the data provision system according to the first example embodiment of the present disclosure.

FIG. 11 is a diagram illustrating a configuration of a data provision system according to a second example embodiment of the present disclosure.

FIG. 12 is a diagram for describing an example of a holding mode of image data in the data provision system according to the second example embodiment of the present disclosure.

FIG. 13 is a diagram for explaining a provision range of image data by the data provision system according to the second example embodiment of the present disclosure.

FIG. 14 is a diagram illustrating a configuration of a data provision system according to a third example embodiment of the present disclosure.

FIG. 15 is a diagram for explaining an example of image data transmission conditions set in the data provision system according to the third example embodiment of the present disclosure.

FIG. 16 is a flowchart illustrating a data transmission operation of the data provision system according to the third example embodiment of the present disclosure.

FIG. 17 is a diagram illustrating an example of image data provided by the data provision system according to the third example embodiment of the present disclosure.

FIG. 18 is a diagram illustrating the configuration of a computer that can function as the data provision system of the present disclosure.

### EXAMPLE EMBODIMENT

First, an outline of an example embodiment of the present disclosure will be described with reference to the drawings. The reference numerals in the drawings attached to this outline are attached to each element for convenience as an example for assisting understanding, and are not intended to limit the present disclosure to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with a device (including a computer) inside or outside the device via a communication interface regardless of wired or wireless. Although there are ports and interfaces at connection points of input and output of each block in the drawing, they are not illustrated.

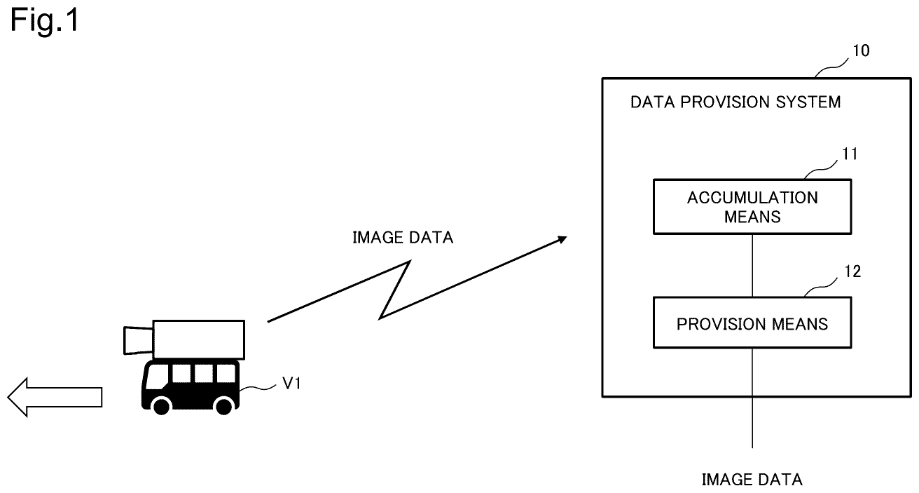

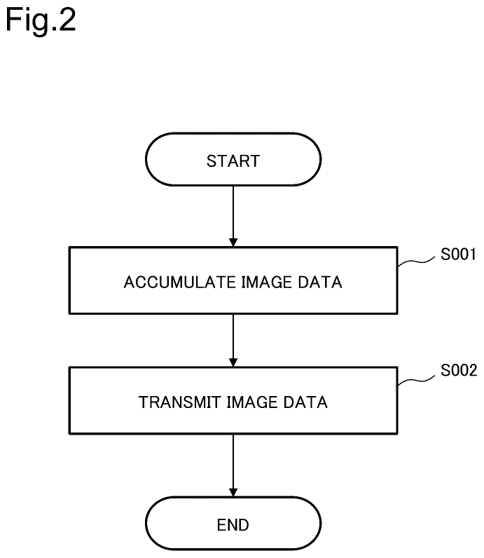

The present disclosure, as illustrated in FIG. 1, can be achieved by a data provision system 10 including an accumulation means 11 and a provision means 12 in an example embodiment. FIG. 2 illustrates a data provision method used in the data provision system 10.

The accumulation means 11 accumulates the image data transmitted to the control center by a mobile body V1 having an operation mode or an automatic operation mode in which the mobile body V1 is operated by remote control from the control center. As a form in which the accumulation means 11 acquires the image data transmitted to the control center, a form in which the data provision system 10 receives provision of the image data from the control center, a form in which the data provision system 10 receives the image data from the mobile body V1 and transfers the image data to the control center, or the like can be adopted.

The provision means 12 provides the image data to a user who wants to utilize the accumulated image data.

As illustrated in FIG. 2, the data provision system 10 configured as described above accumulates the image data transmitted from the mobile body V1 to the control center (step S001). Then, the data provision system 10 provides the image data to a user who wants to utilize the accumulated image data (step S002).

According to the data provision system 10 operating as described above, it is possible to utilize image data captured at the time of remote control or automatic operation. The operator of the data provision system 10 can allocate the service fee for providing the image data and the advertisement fee obtained from the advertiser to the operating cost of the data provision system 10.

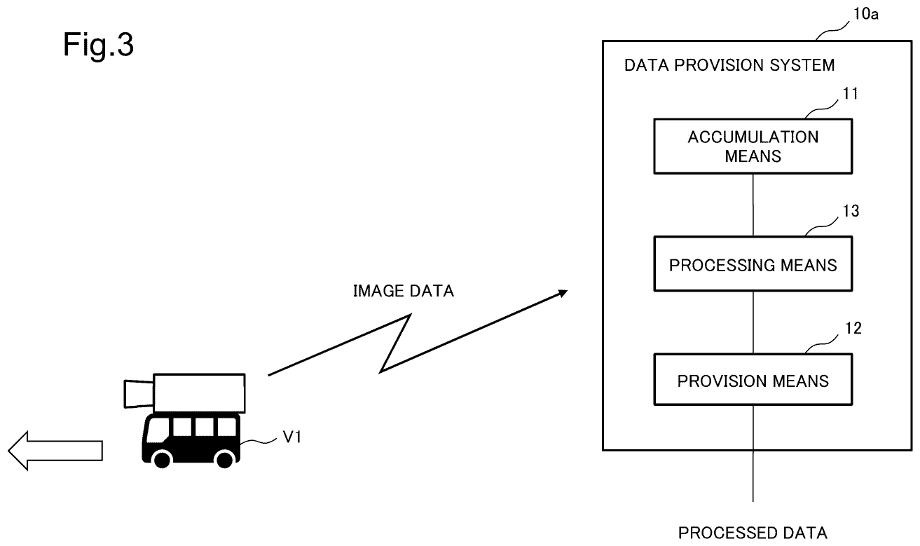

In the above example, it has been described that the data provision system 10 provides the image data, but a configuration in which the data provision system 10 can further process the image data to further increase the added value of the provided data can also be adopted. FIG. 3 illustrates a configuration of a data provision system 10a to which a processing means 13 that generates processed data by processing image data is added. As the processing applied to the image data by the processing means 13, sharpening of the image data, provision of a recognition result of an object shown in an image of the image data, and the like can be considered. The overall data obtained by these processes can be referred to as processed data.

In addition to the processing of the image data described above, the data provision system 10 may be provided with an image data analysis function. In this case, the data provision system 10 performs detection of an abnormal event in an image, extraction of information regarding an object shown in the image, and the like, and provides the accumulated image data to a user who wants to utilize the image data.

### First Example Embodiment

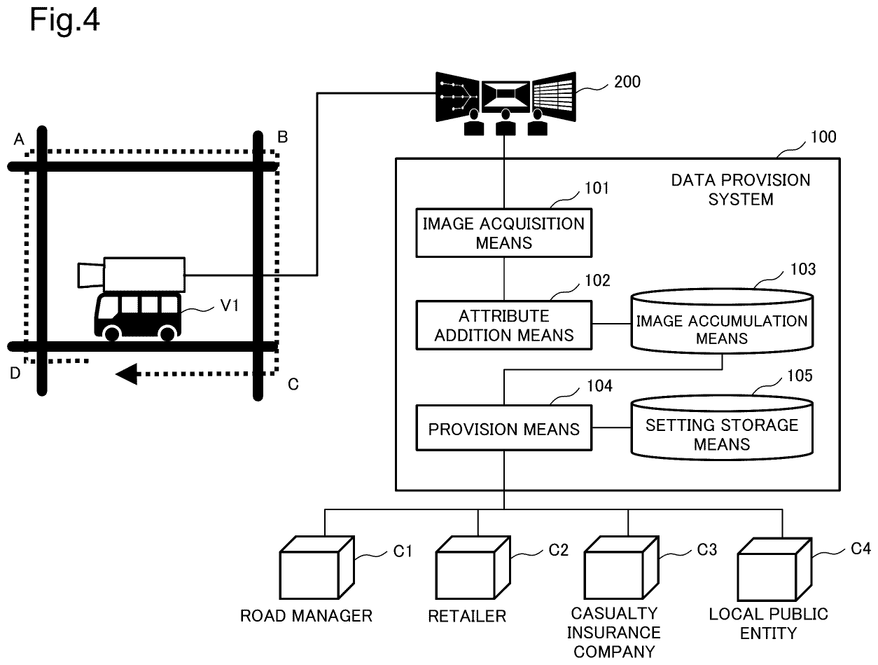

Next, a first example embodiment using a vehicle for passenger transportation as a mobile body of a transmission source of image data will be described in detail with reference to the drawings. FIG. 4 is a diagram illustrating a configuration of the first example embodiment of the present disclosure. Referring to FIG. 4, a configuration including a control center 200 that remotely controls the mobile body V1, a data provision system 100, and user companies C1 to C4 that are data provision destinations is illustrated.

In the present example embodiment, a description will be given assuming that the mobile body V1 goes around a certain route as illustrated on the left side of FIG. 4. Specifically, the description will be given assuming that the mobile body V1 moves in the order of the intersections A, B, C, and D on the left side of FIG. 4, and during that time, transmits image data captured by the mounted camera to the control center 200. In the following description, it is assumed that the mobile body V1 sends an image in front of the own vehicle to the control center 200, but it is also conceivable that the mobile body V1 is mounted with a camera that captures images of the side and the rear. In this case, the mobile body V1 may transmit image data captured by these cameras to the control center 200.

In the control center 200, an operator (pilot) that remotely controls the mobile body (vehicle) V1 is arranged. Specifically, the operator steers the mobile body (vehicle) V1 with reference to a monitor for remote control on which image data transmitted from the mobile body (vehicle) V1 is displayed. In addition to a mode in which the operator directly steers the mobile body (vehicle) V1, a mode in which the operator sends a simple command to the mobile body (vehicle) V1 and the mobile body (vehicle) V1 performs control based on the command can be adopted for the steering of the mobile body (vehicle) V1 by the operator. In the present example embodiment, it is assumed that the mobile body (vehicle) V1 transmits image data of a predetermined resolution or higher to the control center 200 in order to appropriately perform remote control.

The data provision system 100 includes an image acquisition means 101, an attribute addition means 102, an image accumulation means 103, a provision means 104, and a setting storage means 105.

The image acquisition means 101 acquires, from the control center 200, the image data which has been transmitted from the mobile body V1, and sends the image data to the attribute addition means 102. Here, the image acquisition means 101 acquires image data of a predetermined resolution or higher sent to the control center 200 in order to appropriately perform remote control.

The attribute addition means 102 adds attribute information to the image data transmitted from the mobile body V1, and then stores the image data in the image accumulation means 103.

The image accumulation means 103 includes a storage device or the like capable of storing image data transmitted from the mobile body V1 for a certain period of time.

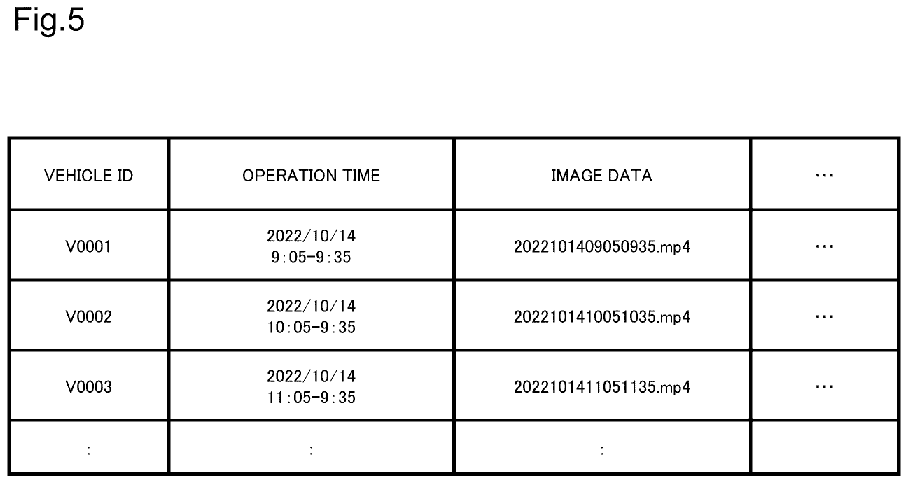

FIG. 5 is a diagram illustrating an example of a holding mode of image data in the image accumulation means 103 of the data provision system 100 according to the present example embodiment. In the example of FIG. 5, the attribute information such as a vehicle ID and an operation time is added to the image data. These pieces of attribute information are used to select image data to be provided to the user companies C1 to C4. For example, in a case where a certain user company requests image data captured by a vehicle V0001 departing at 9:05 AM, the data provision system 100 selects the first image data in FIG. 5. In this manner, the image accumulation means 103 can accumulate the image data transmitted to the control center 200 for each operation of the vehicle for passenger transportation.

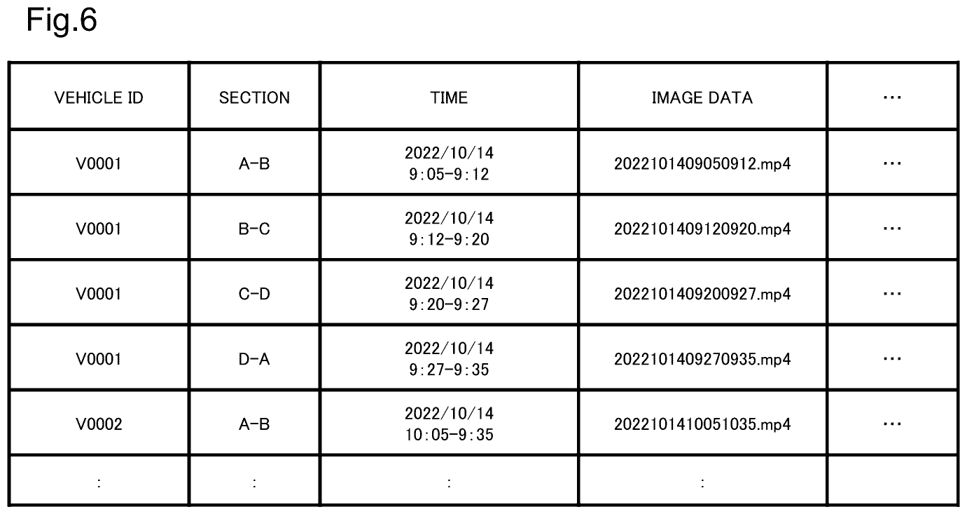

The holding mode of the image data in the image accumulation means 103 is not limited to the example of FIG. 5. For example, as illustrated in FIG. 6, a section field may be added in addition to the vehicle ID and the operation time, and data transmitted from the mobile body V1 may be held in units of sections between intersections. By doing so, in comparison with the example of FIG. 5, it is possible to select and provide image data in finer units.

The image accumulation means 103 may perform processing of deleting or compressing image data that has passed a predetermined storage time limit. In this way, the capacity of the storage device or the like used as the image accumulation means 103 can be saved.

The image acquisition means 101 and the attribute addition means 102 that operate as described above correspond to the accumulation means 11 described above.

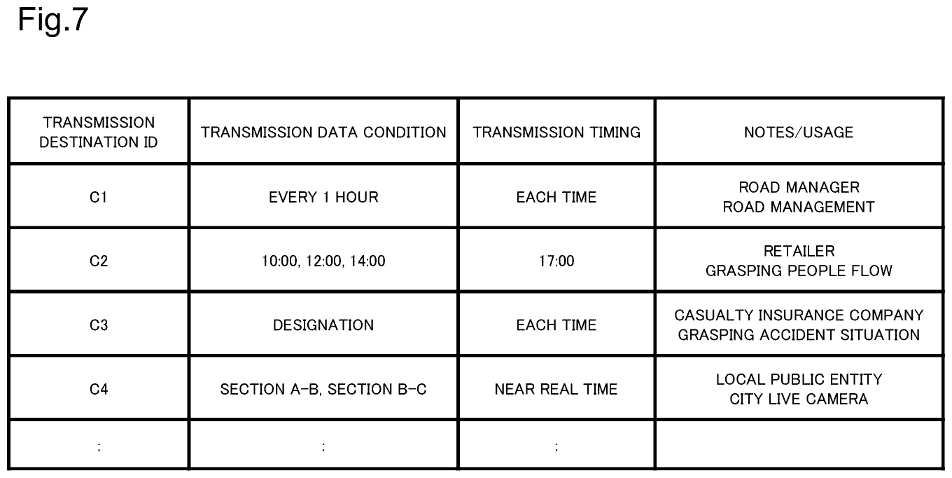

The setting storage means 105 stores setting information including transmission conditions and the like of the image data which are set from the user companies C1 to C4. FIG. 7 is a diagram illustrating an example of setting information including the transmission conditions and the like of the image data in the data provision system according to the first example embodiment of the present disclosure. In the example of FIG. 7, the user company C1 is a road manager, and it is specified that image data captured by the mobile body V1 is transmitted to the user company C1 every hour. The user company C1 can grasp the state of the road by using such data. Of course, the cycle of every hour is merely an example, and the shorter the cycle, the more quickly the abnormality of the road and the presence of a fallen object can be grasped.

The user company C2 is a retailer, and it is specified that image data of 10:00, 12:00, and 14:00 captured by the mobile body V1 is collectively transmitted to the user company C2 at 17:00 every day. The image data at 10:00, 12:00, and 14:00 does not necessarily need to be image data captured by the mobile body V1 departing at the time, and image data captured in a time zone close to or including the designated time can be used. By using such data, the user company C2 can perform fixed point observation of a road leading to the own store, and perform sales prediction, planning of sales promotion measures, and the like.

The user company C3 is a casualty insurance company, and it is specified that the image data including the designated timing is requested and provided at any time. The user company C2 can grasp the accident situation encountered by the subscriber by using such data.

The user company C4 is a local public entity or a company entrusted by a local public entity, and is determined to receive the provision of the image data of the sections A-B and B-C in near real time. By using such data, the user company C4 can disclose image data of a specific section to the resident as a city live camera image, and perform real-time monitoring of an important road section. In the example of FIG. 7, necessary image data is designated by a section, but for example, necessary image data may be designated using a name of a road, an administrative district name, an area indicated by latitude and longitude, or the like.

The examples of the industry types and the setting information of the user companies C1 to C4 described above are merely examples, and can be deployed to user companies of other industry types. For example, a consultant or a department in charge regarding city planning can use the data as basic data for grasping the flow of vehicles and people on the travel section of the mobile body. It is also possible to use the information to grasp the amount of rainfall or snow accumulation by a department in charge of disaster prevention of a local public entity or the like through monitoring of the state of the road surface. Although not illustrated in the example of FIG. 7, in a case where there are a plurality of types of mobile bodies as data transmission sources, the user company may focus on a specific type of mobile body (for example, a bus, a delivery robot, an unmanned aerial vehicle, or the like) and may be allowed to register setting information for receiving provision of image data transmitted from the mobile body. In this way, it is possible to designate a mobile body of a specific type and receive provision of image data.

As described above, the provision means 104 refers to the setting information stored in the setting storage means 105, extracts the corresponding image data from the image accumulation means 103, and transmits (provides) the image data to the user companies C1 to C4. As described above, it is possible to adopt a mode in which the provision means 104 receives a condition including at least one of a photographing time, a place, and a type of a mobile body from a user, and provides image data or the processed data that meets the condition.

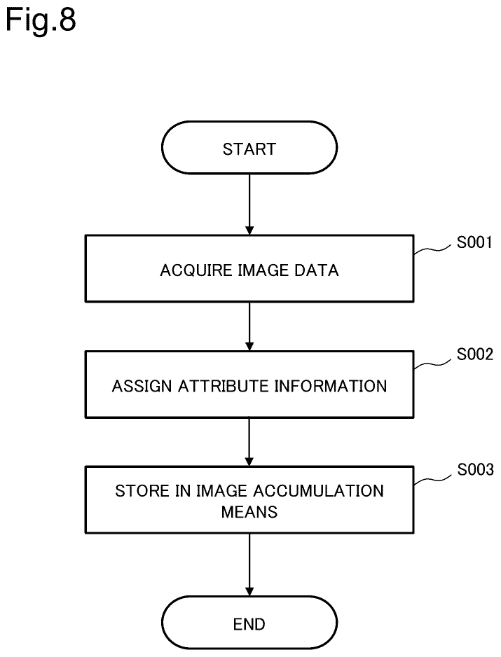

Next, the operation of the present example embodiment will be described in detail with reference to the drawings. FIG. 8 is a flowchart illustrating details of an accumulating operation (step S001 in FIG. 2) of image data in the data provision system 100 according to the first example embodiment of the present disclosure. Referring to FIG. 8, the data provision system 100 acquires the image data transmitted from the mobile body V1 from the control center 200 (step S001).

Next, the data provision system 100 adds attribute information to the image data transmitted from the mobile body V1 (step S002). Further, the data provision system 100 stores the image data to which the attribute is added in the image accumulation means 103 (step S003).

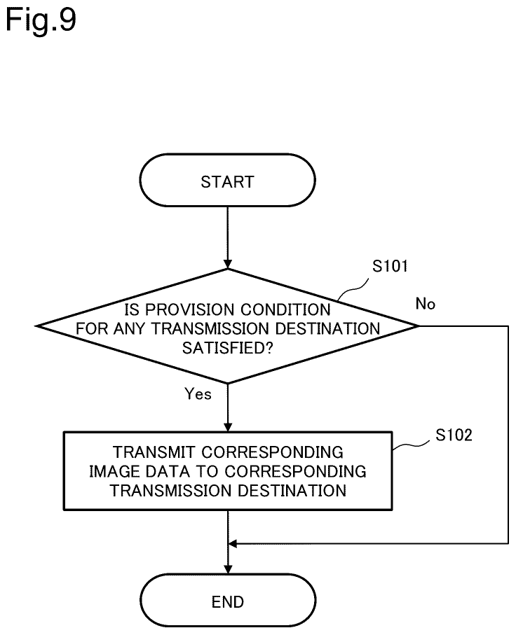

FIG. 9 is a flowchart illustrating an image data providing operation of the data provision system 100 according to the first example embodiment of the present disclosure. Referring to FIG. 9, first, the data provision system 100 refers to the setting information held in the setting storage means 105, and checks whether the data provision conditions for the transmission destinations (the user companies C1 to C4) are satisfied (step S101).

In a case where it is determined that the condition for providing data to any of the destinations is satisfied (Yes in step S101), the data provision system 100 selects image data and transmits the image data to the corresponding destination (step S102). In a case where it is determined that the data provision condition is not satisfied (No in step S101), a data provision system 100b does not transmit the image data.

According to the data provision system 100 operating as described above, it is possible to provide an image with high resolution used for remote control to the user companies C1 to C4 that want to provide image data.

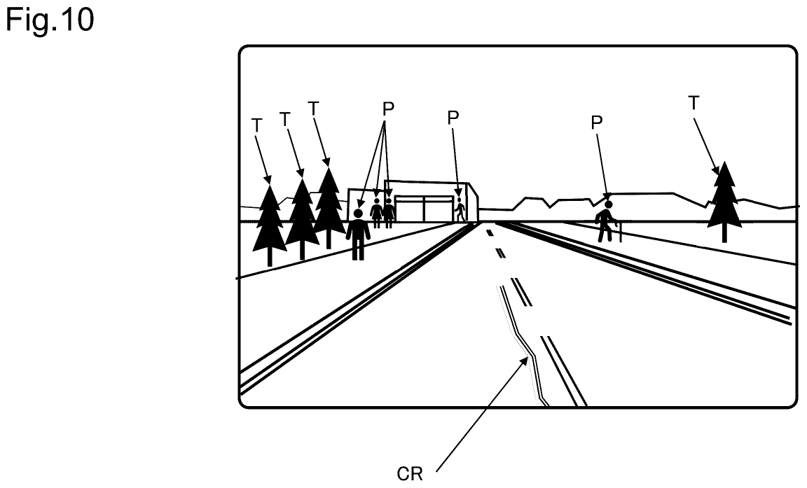

FIG. 10 is an example of image data provided to the user companies C1 to C4 of the data provision system 100. The user companies C1 to C4 can confirm people P, standing trees T, cracks CR of the road, and the like shown in the image data, and can use them for the applications. For example, the user company C1, which is a road manager described above, can grasp the presence of fallen objects, animal dead bodies, and the like in addition to the cracks CR of the road at an early stage from the image data obtained at a cycle of every hour.

The user company C2, which is a retailer, can grasp daily manpower and people flow from the image data sent every day, and perform sales prediction, planning of sales promotion measures, and the like. The user company C3, which is a casualty insurance company, can grasp the accident situation encountered by the subscriber. The user company C4, which is a local public entity or a company entrusted by the local public entity, can disclose the city live camera image using the image data to the residents.

The reference signs indicating the people, the standing trees, and the cracks of the road in FIG. 10 may be used as they are added by the mobile body V1 or the control center 200, but may be omitted. In this case, the object recognition is performed on the user companies C1 to C4 side. In the mobile body V1 or the control center 200, information regarding moving speeds or moving directions of people or vehicles in the image may be added. These may be provided to the user companies C1 to C4 as they are or may be deleted.

In the above-described example embodiment, the description has been given assuming that the data provision system 100 selects the image data to be transmitted using the time information specified in the setting information set in advance, but the image data to be transmitted may be selected using other information. For example, it is also possible to adopt a configuration in which conditions including at least one or more of a place and a type of a mobile body are received, and image data meeting these conditions is provided. For example, in a case where image data including a section is obtained as illustrated in FIG. 6, the section and time may be selected so that image data to be provided can be selected.

### Second Example Embodiment

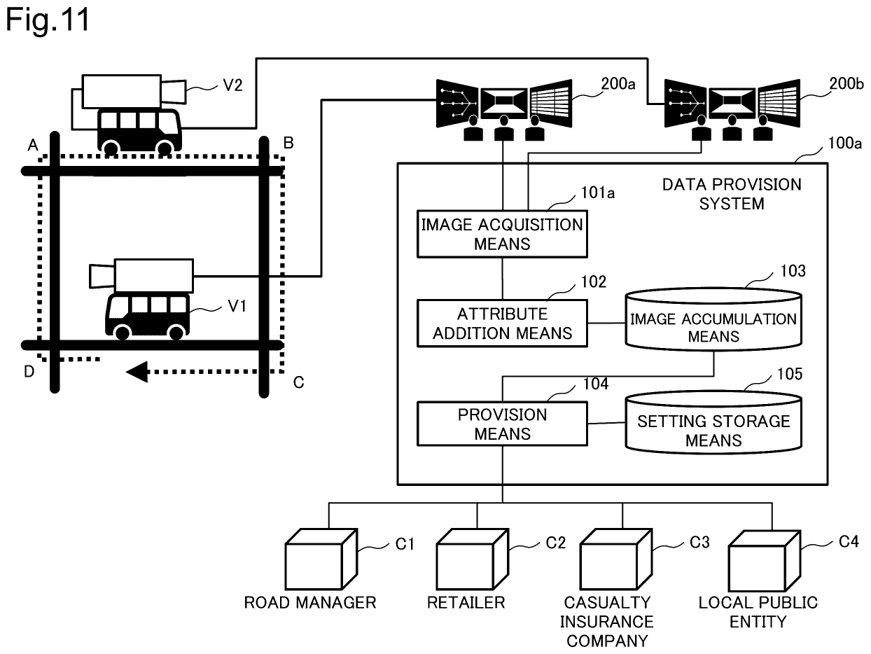

Next, a second example embodiment in which there is a plurality of control centers 200 and the data provision system receives image data from these control centers 200 and aggregates and manages the image data will be described in detail with reference to the drawings. FIG. 11 is a diagram illustrating a configuration of the second example embodiment of the present disclosure. A difference from the first example embodiment illustrated in FIG. 4 is that control centers 200a and 200b of a business operator (also referred to as a company) that operates a passenger transportation business exist, and a data provision system 100a acquires image data transmitted from mobile bodies V1 and V2 from the control centers 200a and 200b. Since other configurations are similar to those of the first example embodiment, description thereof will be omitted, and differences will be mainly described below.

In the example of FIG. 11, the mobile bodies V1 and V2 are assumed to be vehicles of passenger carriers that operate on the same route with different operation schedules.

An image acquisition means 101a of the data provision system 100a acquires, from the control center 200a, the image data transmitted from the mobile body V1, and sends the image data to the attribute addition means 102. Similarly, the image acquisition means 101a of the data provision system 100a acquires, from the control center 200b, the image data transmitted from the mobile body V2, and sends the image data to the attribute addition means 102.

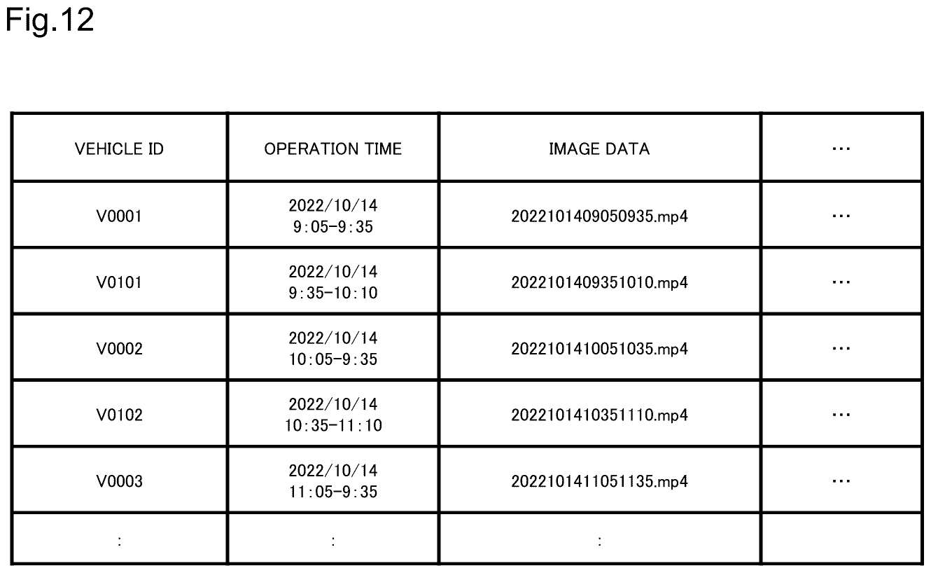

FIG. 12 is a diagram illustrating an example of a holding mode of image data in the image accumulation means 103 of the data provision system 100a according to the present example embodiment. The holding mode is basically the same as the holding mode of the image data illustrated in FIG. 5, but is different in that the number of image data is increased. Specifically, in the example of FIG. 5, the image data transmitted from the vehicles having vehicle IDs V0001, V0002, and V0003 are accumulated, but in the example of FIG. 12, the image data transmitted from the vehicles having the vehicle IDs V0101 and V0102 are added. As described above, according to the present example embodiment, it is possible to enrich the amount and frequency of image data by collecting image data in a plurality of business operators. The image data in the image accumulation means 103 may be assigned with an ID for each business operator operating the passenger transportation business. A plurality of image accumulation means 103 may be provided. For example, the image accumulation means 103 may exist for each ID of a business operator that operates a passenger transportation business or for each vehicle ID.

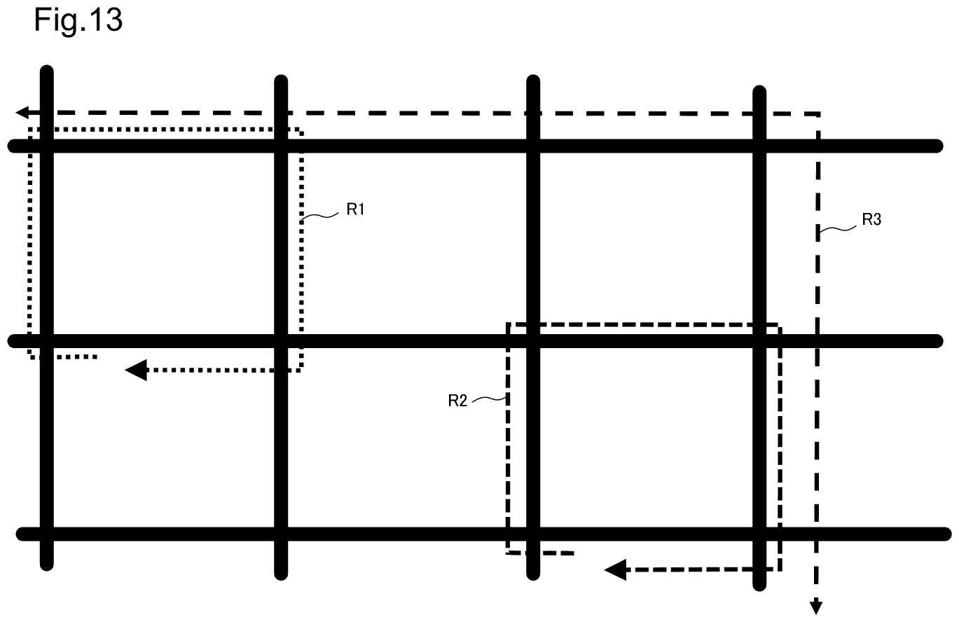

In the example of FIG. 11, the description has been given assuming that the same route is a vehicle of a passenger carrier operating with different operation schedules, but the mobile body from which the data provision system 100a collects image data is not limited thereto. For example, the data provision system 100a can acquire image data from the control centers of a plurality of passenger carriers providing services in different areas, and can be a target of provision. For example, the data provision system 100a can acquire image data transmitted from a mobile body (vehicle) traveling on a route R1, a route R2, and a route R3 illustrated in FIG. 13, and can add the image data as a transmission target to the user companies C1 to C4. With such a configuration, the data provision system 100a can provide image data captured in a wider range to the user companies C1 to C4. In providing such image data captured in a wide range, selection of image data may be received from a user company using a map showing routes R1 to R3 as illustrated in FIG. 13. For example, a user interface (UI) may be provided that presents the map illustrated in FIG. 13 to the user company C3 that receives provision of image data specifying a place or time, and selects a route on the map, so that a transmission request of the image data can be made. There is no geographical restriction on an area that can be handled by the data provision system 100a. A route in which a vehicle for passenger transportation is operated by automatic operation or remote control is often an important route in which traffic demand is high. By linking the form of the present disclosure with the map information providing system, it is also possible to construct a site confirmation and local site experience system capable of confirming an image with high image quality and realistic feeling without going to the site.

In the above-described example embodiment, the description has been given assuming that the data provision system 100 selects the image data to be transmitted using the time information specified in the setting information set in advance, but the image data to be transmitted may be selected using other information. For example, it is also possible to adopt a configuration in which setting information including (photographing) time and a type of a mobile body is received, and image data meeting these conditions is provided.

### Third Example Embodiment

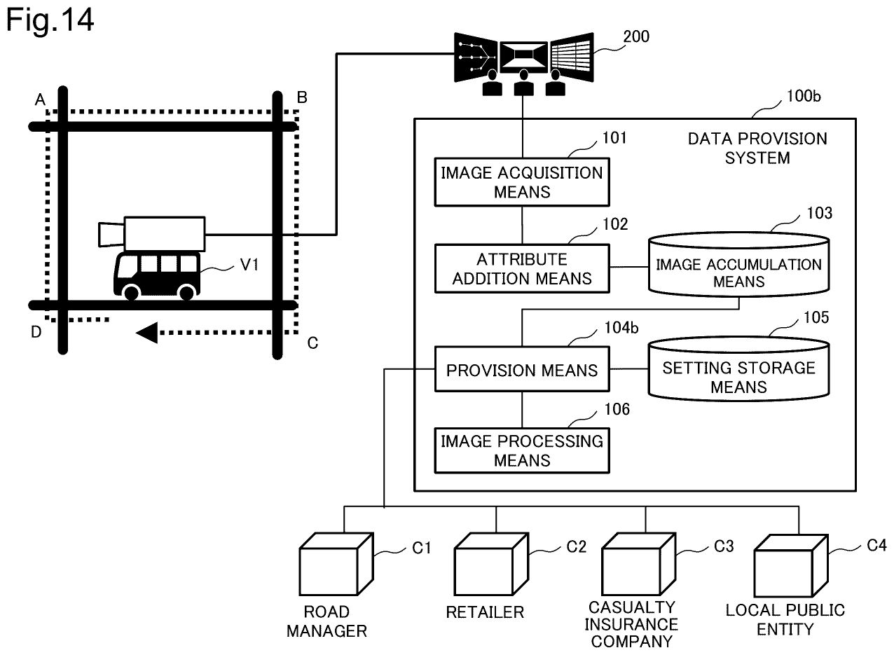

Next, a third example embodiment in which a data provision system performs processing in consideration of privacy of a person or the like in image data will be described in detail with reference to the drawings. FIG. 14 is a diagram illustrating a configuration of the third example embodiment of the present disclosure. A difference from the first example embodiment illustrated in FIG. 4 is that an image processing means 106 is added to the data provision system 100b so that desired image processing can be performed on image data to be transmitted to the user companies C1 to C4. Since other configurations are similar to those of the first example embodiment, description thereof will be omitted, and differences will be mainly described below.

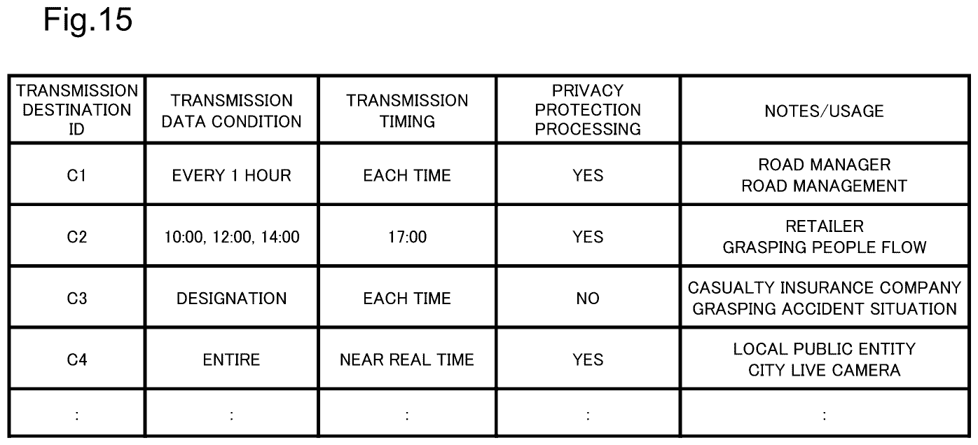

FIG. 15 is a diagram illustrating an example of setting information including the transmission conditions and the like of the image data in the data provision system according to the present example embodiment. In the example of FIG. 15, in addition to the setting information of the first example embodiment, a field for setting necessity of privacy protection processing (anonymization processing) is provided for each user company. In the example of FIG. 15, the user company C1, the user company C2, and the user company C4 set “ON”for the privacy protection processing.

A provision means 104b of the present example embodiment refers to the setting information stored in the setting storage means 105, extracts the corresponding image data from the image accumulation means 103, and transmits (provides) the image data to the user companies C1 to C4. At that time, in a case where the corresponding user company sets that there is privacy protection processing on the image data to be transmitted, the provision means 104b requests the image processing means 106 to process the image data to be transmitted to the corresponding user company. The operation of the provision means 104 in a case where the corresponding user company sets that the privacy protection processing for the image data to be transmitted is not performed is similar to that in the first example embodiment, and thus the description thereof will be omitted. Processing to image data to be transmitted to a user company is requested.

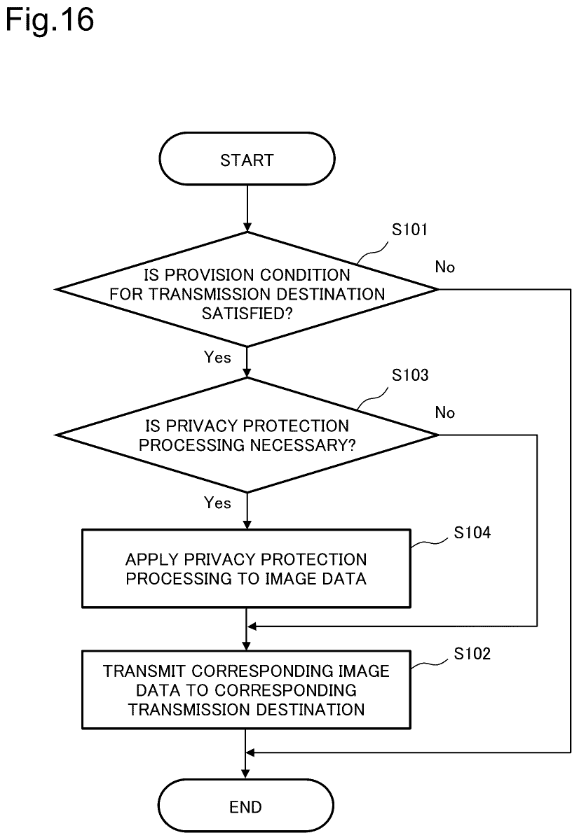

Next, the operation of the present example embodiment will be described in detail with reference to FIG. 16. FIG. 16 is a flowchart illustrating an image data providing operation of the data provision system 100b according to the third example embodiment of the present disclosure. Referring to FIG. 16, first, the data provision system 100b refers to the setting information held in the setting storage means 105, and checks whether the data provision conditions for the transmission destinations (the user companies C1 to C4) are satisfied (step S101).

In a case where it is determined that the data provision condition to any one of the transmission destinations is satisfied (Yes in step S101), the data provision system 100b confirms necessity of privacy protection processing in the setting information (step S103). In a case where the privacy protection processing is set to “ON” (Yes in step S103), the data provision system 100b performs the privacy protection processing on the transmission target image data (step S104).

On the other hand, in a case where the privacy protection processing is set to “OFF” (No in step S103), the data provision system 100b omits the privacy protection processing (to step S102).

Finally, the data provision system 100b transmits the image data subjected to the privacy processing as necessary to the corresponding transmission destination (step S102). In a case where it is determined that the data provision condition is not satisfied (No in step S101), a data provision system 100b does not transmit the image data.

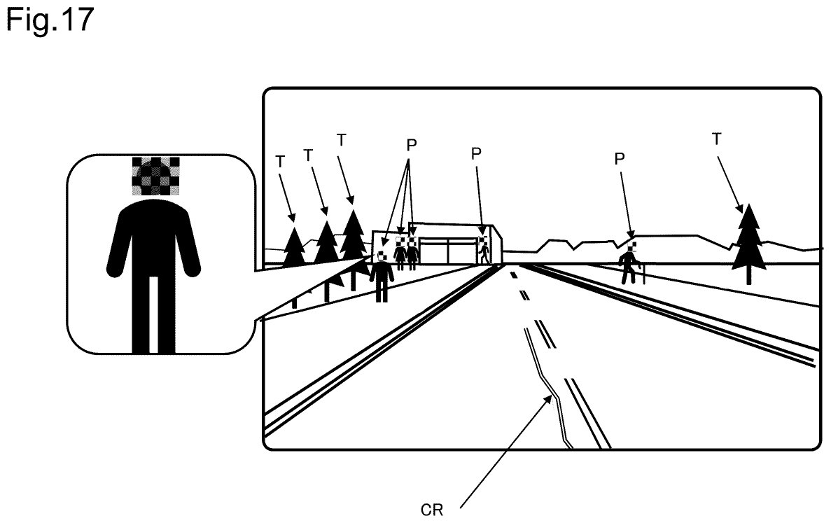

FIG. 17 is a diagram illustrating an example of image data (processed data) provided to the user companies C1 to C4 in a case where the privacy protection processing is set to “ON”. The difference from the image data of the first example embodiment illustrated in FIG. 10 is that mosaic processing is performed on the face parts of the people P. In this way, the user company C1 (road manager), the user company C2 (retailer), and the user company C4 (local public entity) can utilize the image data received with security. As illustrated in FIG. 10, image data in which mosaic processing is not performed on the face parts of the people P is transmitted to the user company C3 (casualty insurance company). As a result, the user company C3 (casualty insurance company) can grasp the party to the accident.

In the example of FIG. 17, the mosaic processing is performed on the face parts of the people P. However, it is a matter of course that the privacy protection processing may be performed on a part other than the face of the person. For example, in a case where a vehicle is included in the image data, the privacy protection processing may be performed on a license plate portion of the vehicle. In the example of FIG. 17, it has been described that the mosaic processing is applied to a region where an image is desired to be hidden as the privacy protection processing, but mask processing or the like may be applied as the privacy protection processing.

In the above example embodiment, an example in which the mobile body is a vehicle for passenger transportation has been described, but the mobile body may be another vehicle, a ship, an unmanned flying object, or the like. Also in this case, the data provision system can respond to demands from various users by receiving image data from these mobile bodies and giving appropriate attribute information.

### Hardware Configuration

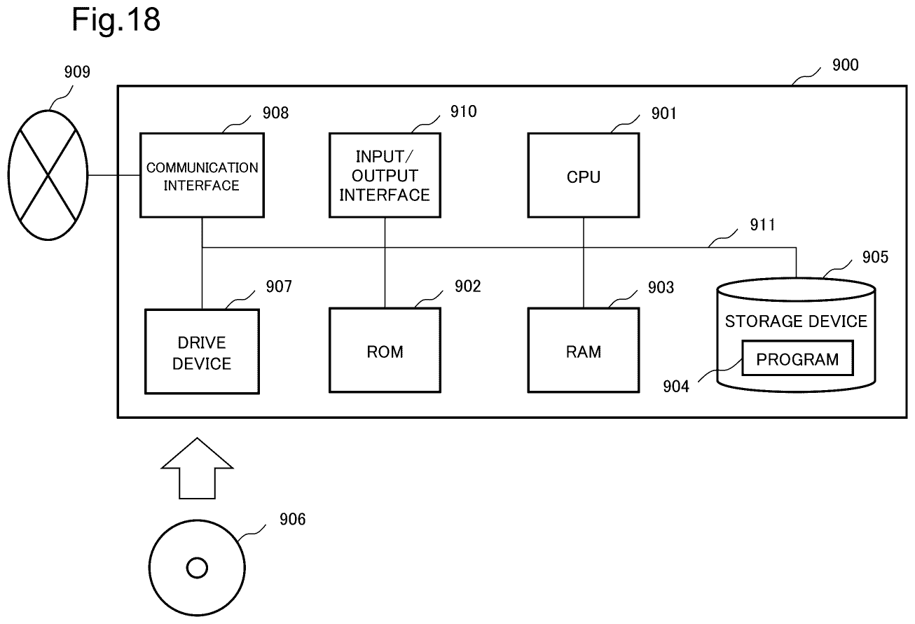

In each example embodiment of the present disclosure, each component of each device indicates a block of a functional unit. Part or all of each component of each device is achieved by, for example, an any combination of an information processing device 900 and a program as illustrated in FIG. 18. FIG. 18 is a block diagram illustrating an example of a hardware configuration of the information processing device 900 that achieves each component of each device. The information processing device 900 includes the following configuration as an example.
CPU (Central Processing Unit) 901
ROM (Read Only Memory) 902
RAM (Random Access Memory) 903
Program 904 loaded into RAM 903
Storage device 905 storing program 904
Drive device 907 that reads and writes recording medium 906
Communication interface 908 connected with communication network 909
Input/output interface 910 for inputting/outputting data
Bus 911 connecting each component

Each component of each device in each example embodiment is achieved by the CPU 901 acquiring and executing a program 904 for achieving these functions. That is, the CPU 901 of FIG. 18 may execute a program for acquiring and accumulating image data from the mobile body and a program for selecting the content of the image data and the transmission destination, and may perform update processing of each calculation parameter held in the RAM 903, the storage device 905, or the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) storage medium.

There are various modifications of the method of achieving each device. For example, each device may be achieved by any combination of the information processing device 900 and the program separate for each component. A plurality of components included in each device may be achieved by any combination of one information processing device 900 and a program. That is, the present invention can be achieved by a computer program that causes a processor mounted in each of the devices described in the first to fifth example embodiments to execute each of the above-described processes using the hardware.

Some or all of the constituent elements of each device are achieved by other general-purpose or dedicated circuits, processors and the like, or a combination thereof. These may be configured by a single chip or may be configured by a plurality of chips connected via a bus.

Some or all of the components of each device may be achieved by a combination of the above-described circuit and the like and a program.

In a case where some or all of the components of each device are achieved by a plurality of information processing devices, circuits, and the like, the plurality of information processing devices, circuits, and the like may be arranged in a centralized manner or in a distributed manner. For example, the information processing device, the circuit, and the like may be achieved as a form in which each is connected via a communication network, such as a client and server system or a cloud computing system.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a mode in which various modifications are made.

The first to third example embodiments described above can be made into different example embodiments by combining the features. For example, by combining the acquisition function of the image data from the plurality of control centers 200 of the second example embodiment and the third example embodiment, it is possible to construct an acquired data provision system that performs privacy protection processing on the image data acquired from the plurality of control centers 200 and then provides the image data.

Some or all of the above example embodiments may be described as the following Supplementary Notes, but are not limited to the following.

### Supplementary Note 1

A data provision system including:
an accumulation means that accumulates image data transmitted to a control center by a mobile body equipped with an automatic operation mode or an operation mode for operating by means of remote control from the control center; and
a provision means that provides, to a user who wants to utilize the accumulated image data or processed data, the processed data generated by processing the image data.

### Supplementary Note 2

The mobile body may be a vehicle for passenger transportation including an operation mode in which the mobile body is driven by the remote control operated by one or more companies, and
the accumulation means of the data provision system may accumulate the image data transmitted to the control center for each operation of the vehicle for passenger transportation.

### Supplementary Note 3

The mobile body may transmit image data with a predetermined resolution or higher to the control center by using a network constructed for remote control of the mobile body, and
the accumulation means of the data provision system may receive and accumulate image data having the predetermined resolution or higher.

### Supplementary Note 4

A plurality of the control centers may exist for each company operating a passenger transportation business, and
the accumulation means of the data provision system may receive provision of image data from the plurality of control centers.

### Supplementary Note 5

The data provision system may further include an image processing means that performs processing to prevent a person included in the image data from being identified.

### Supplementary Note 6

The provision means of the data provision system may receive a condition including at least one of a photographing time, a place, and a type of a mobile body from the user, and may provide image data or the processed data that meets the condition.

### Supplementary Note 7

A data provision method including:
accumulating image data transmitted to a control center by a mobile body equipped with an automatic operation mode or an operation mode for operating by means of remote control from the control center; and
providing, to a user who wants to utilize the accumulated image data or processed data, the processed data generated by processing the image data.

### Supplementary Note 8

A recording medium having stored therein a program causing a computer to execute:
accumulating image data transmitted to a control center by a mobile body equipped with an automatic operation mode or an operation mode for operating by means of remote control from the control center; and
providing, to a user who wants to utilize the accumulated image data or processed data, the processed data generated by processing the image data.

The forms of the Supplementary Notes 7 and 8 can be expanded to the forms of the Supplementary Notes 2 to 6, similarly to the Supplementary Note 1.

The disclosure of the above PTL is incorporated herein by reference, and can be used as a basis or part of the present invention as necessary. Within the frame of the entire disclosure (including the claims) of the present invention, it is possible to change and adjust the example embodiments or examples further based on of the basic technical idea thereof. Various combinations or selections (including partial deletions) of various disclosure elements (each element of each claim, each element of each example embodiment or example, each element of each drawing, and the like are included) can be made within the frame of the disclosure of the present invention. That is, it is a matter of course that the present invention includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even when not stated otherwise. Furthermore, it is also deemed that in the matters disclosed in the document cited above, using part or all of the matters disclosed in the document in combination with the matters described in the present specification as part of the disclosure of the present invention according to the gist of the present invention as necessary is included in the matters disclosed in the present application.

### REFERENCE SIGNS LIST

11 accumulation means
12 provision means
13 processing means
10, 10a, 100, 100a, 100b data provision system
101 image acquisition means
102 attribute addition means
103 image accumulation means
104 provision means
105 setting storage means
106 image processing means
200, 200a, 200b control center
900 information processing device
901 CPU (Central Processing Unit)
902 ROM (Read Only Memory)
903 RAM (Random Access Memory)
904 program
905 storage device
906 recording medium
907 drive device
908 communication interface
909 communication network
910 input/output interface
911 bus
V1, V2 mobile body
C1 to C4 user company
P person
T standing tree
CR crack

What is claimed is:

1. A data provision system comprising:
at least one memory storing instructions; and
at least one processor configured to execute the instructions to:
accumulate image data transmitted to a control center by a mobile body equipped with an automatic operation mode or an operation mode for operating by means of remote control from the control center; and
provide, to a provision means that provides, to a user who wants to utilize the accumulated image data or processed data, the processed data generated by processing the image data.

2. The data provision system according to claim 1, wherein
the mobile body is a vehicle for passenger transportation including an operation mode in which the mobile body is driven by the remote control operated by one or more companies, and the at least one processor is further configured to execute the instructions to:
accumulate the image data transmitted to the control center for each operation of the vehicle for passenger transportation.

3. The data provision system according to claim 1, wherein
the mobile body transmits image data with a predetermined resolution or higher to the control center by using a network constructed for remote control of the mobile body, and the at least one processor is further configured to execute the instructions to:
accumulate image data having the predetermined resolution or higher.

4. The data provision system according to claim 1, wherein
a plurality of the control centers exist for each company operating a passenger transportation business, and wherein the at least one processor is further configured to execute the instructions to:
receive provision of image data from the plurality of control centers.

5. The data provision system according to claim 1, wherein the at least one processor is further configured to execute the instructions to:
perform processing to prevent a person included in the image data from being identified.

6. The data provision system according to claim 1, wherein the at least one processor is further configured to execute the instructions to:
receive a condition including at least one of a photographing time, a place, and a type of a mobile body from the user, and provide image data or the processed data that meets the condition.

7. A data provision method comprising:
accumulating image data transmitted to a control center by a mobile body equipped with an automatic operation mode or an operation mode for operating by means of remote control from the control center; and
providing, to a user who wants to utilize the accumulated image data or processed data, the processed data generated by processing the image data.

8. A non-transitory recording medium having stored therein a program causing a computer to execute:
accumulating image data transmitted to a control center by a mobile body equipped with an automatic operation mode or an operation mode for operating by means of remote control from the control center; and
providing, to a user who wants to utilize the accumulated image data or processed data, the processed data generated by processing the image data.
